(19) United States
(12) Patent Application Publication
(10) Pub. No.: US 2021/0015698 A1
(43) Pub. Date: Jan. 21, 2021

(54) APPARATUS AND METHOD FOR TREATING VASCULAR DISORDERS

(71) Applicant: Anthony J. SPYROPOULOS, Richardson, TX (US)

(72) Inventor: Anthony J. SPYROPOULOS, Richardson, TX (US)

(21) Appl. No.: 16/515,828

(22) Filed: Jul. 18, 2019

(51) Int. Cl. A61H 9/00

(52) U.S. Cl. CPC A61H 9/0092; A61H 2205/10; A61H 2205/06; A61H 2201/501

(57) ABSTRACT

An apparatus for performing compression therapy on a person. The apparatus comprises: i) a sleeve configured to encircle a first portion of a limb of the person and to hold the apparatus in place on the limb of the person; ii) a shell configured to encircle the first portion of the limb of the person, wherein the shell is positioned outside of the sleeve with respect to the first portion of the limb; iii) a bladder comprising at least one air cell, wherein the bladder is disposed between the sleeve and the shell; and iv) a control unit comprising an air pump, the control unit configured to cause the air pump to pump air into the at least one air cell, thereby inflating the bladder. The control unit is disposed within an interior compartment of the shell.

### TECHNICAL FIELD

The present application relates generally to a therapeutic device for treating deep vein thrombosis (DVT) and other vascular disorders and, more specifically, to a cuff-style intermittent pneumatic compression (IPC) device for applying sequential compression to prevent blood clots in the bodily extremities.

### BACKGROUND

Intermittent pneumatic compression (IPC) devices are uses in the treatment of a variety of physical disorders, including the prevention and reduction of blood clots, such as those caused by deep vein thrombosis (DVT). A conventional IPC device is a cuff that wraps around a limb, typically the leg, and applies a series of compressions to the limb. The compressions replicate the effect of movement in the muscles of the limb, which stimulates blood flow and prevents blood from pooling in the extremities. The compressions are generated by pumping air into bladders or air cells inside the cuff. The IPC device often attaches to an external air pump by means of a hose.

One notable use of IPC devices is by airline passengers, who frequently suffer DVT effects because they are relatively immobile for hours at a time in cramped airline seats. However, conventional IPC devices are often bulk, noisy, and require an external power source, so that these IPC devices are not readily portable or convenient to use on airplanes or in other public places. This is especially true when an external air pump and connecting hose are used. Additionally, many IPC device also require custom fitting for different sizes.

In sum, the noise and bulk of existing devices are incompatible with daily, discreet, ambulatory wear, especially under clothing. No products currently exist in the medical or consumer healthcare market that combine the efficacy of available active IPC devices (or serial compression devices) with the form-factor necessary for unobtrusive wear, with regard to size, weight and noise emission necessary to achieve wide patient adoption and consumer appeal.

Therefore, there is a need for an improved therapy device for providing compression therapy to treat vascular disorders. In particular, there is a need for a compression therapy device that eliminates bulky and noise components in a truly portable, quiet, and discreet form factor.

### SUMMARY

To address the above-discussed deficiencies of the prior art, it is a primary object to provide, an apparatus for performing compression therapy on a person. The apparatus comprises: i) a sleeve configured to encircle a first portion of a limb of the person and to hold the apparatus in place on the limb of the person; ii) a shell configured to encircle the first portion of the limb of the person, wherein the shell is positioned outside of the sleeve with respect to the first portion of the limb; iii) a bladder comprising at least one air cell, wherein the bladder is disposed between the sleeve and the shell; and iv) a control unit comprising an air pump, the control unit configured to cause the air pump to pump air into the at least one air cell, thereby inflating the bladder. The control unit is disposed within an interior compartment of the shell.

In an embodiment, the sleeve is removably attached to the shell and to the bladder such that the shell and the bladder are held in place with respect to each other.

In another embodiment, the shell is substantially rigid such that the diameter of the shell is substantially fixed when the shell is encircling the first portion of the limb.

In still another embodiment, the inflation of the bladder causes the bladder to press inward against the sleeve such that a compression is applied to the first portion of the limb.

In yet another embodiment, the control unit is further configured to cause the air pump to withdraw air from the at least one air cell, thereby deflating the bladder.

In a further embodiment, the control unit is further configured to cause the air pump to intermittently inflate and deflate the bladder, thereby applying a plurality of compressions to the first portion of the limb.

In a still further embodiment, the control unit further comprises an interface configured to receive input information from the person, where the control unit uses the input information to control the plurality of compressions applied to the first portion of the limb.

In a yet further embodiment, the control unit uses the input information to control an amount of pressure associated with the plurality of compressions applied to the first portion of the limb.

In one embodiment, the control unit uses the input information to control a frequency associated with the plurality of compressions applied to the first portion of the limb.

In another embodiment, the control unit uses the input information to control a duration associated with the plurality of compressions applied to the first portion of the limb.

In a further embodiment, the interface comprises a wireless transceiver configured to communicate with a remote control device operated by the person.

In an embodiment, the remote control device operated by the person comprises a mobile phone.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a compression therapy device worn on the leg of a user according to one embodiment of the disclosure.

FIG. 2 illustrates a perspective view of the compression therapy device according to one embodiment of the disclosure.

FIG. 3 illustrates an exploded view of the compression therapy device according to one embodiment of the disclosure.

FIG. 4 illustrates an exploded view of the compression therapy device according to another embodiment of the disclosure.

FIG. 5 illustrates in greater detail the control unit of the compression therapy device according to one embodiment of the disclosure.

### DETAILED DESCRIPTION

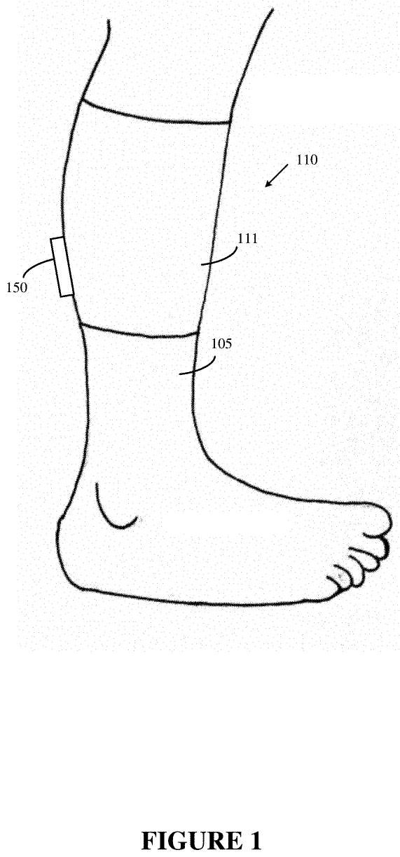

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged compression therapy device.

FIG. 1 illustrates compression therapy device 110 worn on leg 105 of a user according to one embodiment of the disclosure. Compression therapy device (CTD) 110 comprises control unit 150, which activates and controls the operation of CTD 110 and the therapeutic action provided by CTD 110. In FIG. 1, CTD 110 wraps around the calf of leg 105. However, this example is by way of illustration only and should not be construed to limit the applicability of CTD 110. In other uses, CTD 110 may be wrapped, for example, around the thigh or any part of the arm of a user.

One exemplary function of compression therapy device 110 is to perform sequential compression therapy that treats or prevents against certain health disorders, such deep vein thrombosis (DVT) and various venous insufficiencies. In an advantageous embodiment, CTD 110 combines and configures the mechanical housing of control unit 150 and wrap-around module 111 in such a way as to be detachable and interchangeable with a variety of alternative embodiments, effectively providing an all-in-one therapeutic device.

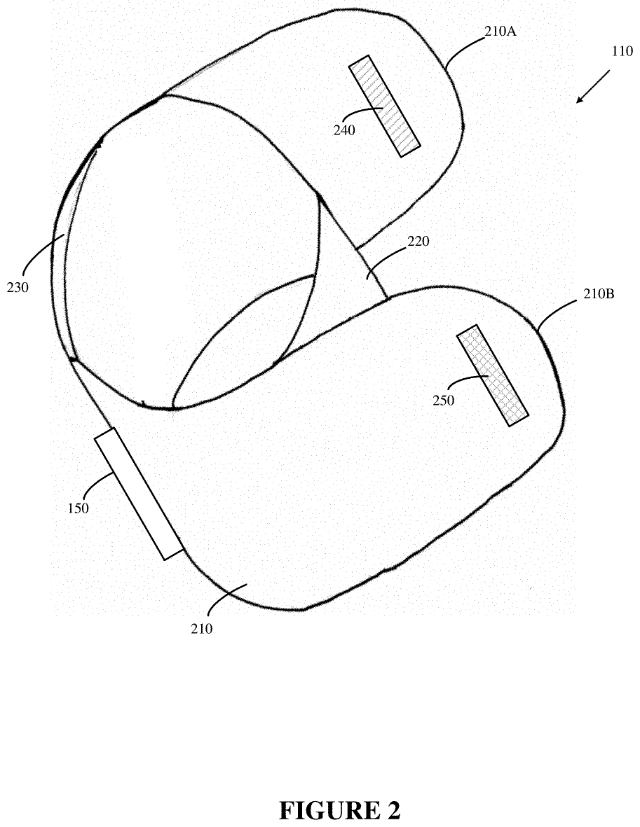

FIG. 2 illustrates a perspective view of compression therapy device (CTD) 110 according to one embodiment of the disclosure. CTD 110 comprises control unit 150 and further shell 210, sleeve 220, and air cell 230. Air cell 230 is disposed between the interior surface of shell 210 and the exterior surface of sleeve 220. CTD 110 wraps around the user limb and controls an internal inflatable bladder in order to provide increased blood flow relief to the user.

In one embodiment, shell 210 comprises a rigid structure that is outside (with respect to the user's skin) of air cell 230. Air cell 230 is a flexible bladder formed from a single or segmented airtight bag-like structure, pneumatically connected to a pumping unit in control unit 150. A conduit (not shown), such as a hose or other tube-like structure, carries the pumped air from the control unit 150 through an opening (not shown) in shell 210 to the air cell 230. If segmented, air cell 230 may inflate and deflate the segments separately and/or sequentially.

Sleeve 220 comprises a fabric garment or wrap that attaches to both shell 210 and air cell 230 to retain air cell 230 and shell 210 in contact with each other and in close engagement with the skin of the user during therapeutic treatment. Thus, sleeve 220 serves to hold shell 210 and air cell 230 in place on the user's limb. Preferably, the fabric is made of a comfortable, form-fitting material, intended to form-fit to human anatomy. Rigid outer shell 210 prevents the outward-facing surface of air cell 230 from expanding away from the limb while inflating. Instead, shell 210 forces the inner surface of air cell 230 inward against sleeve 220 and against the limb wrapped by sleeve 230. Thus, compression is applied to the limb.

Shell 210 comprises distal ends 210A and 210B and further comprises closures 240 and 250. Shell 210 is wrapped around a limb by closing distal ends 210A and 210B together. When shell 210 is wrapped around the limb, distal end 210B is positioned on the inside against sleeve 220 and distal end 210A is positioned outside and overlaps distal end 210B. In this position, closure 240, which faces inward, and closure 250, which faces outward, are configured to releasably connect to each other to prevent shell 210 from opening during operation. No particular closure device is required. However, in an advantageous embodiment, closures 240 and 250 may comprise a hook and mesh closure, such as Velcro®, that firmly closes distal ends 210A and 210B of shell 210 together.

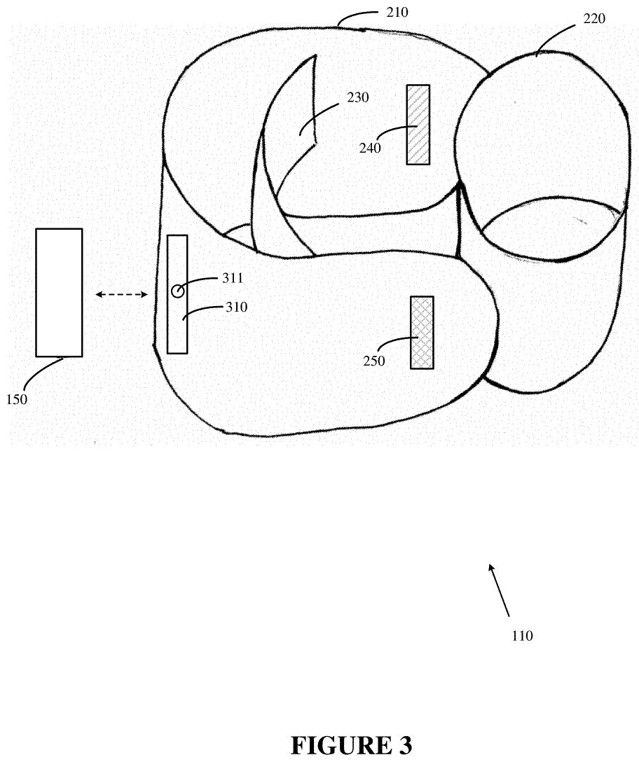

FIG. 3 illustrates an exploded view of compression therapy device (CTD) 110 according to one embodiment of the disclosure. Shell 210 further comprises mount 310 that is configured to removably couple (as indicated by dotted arrows) control unit 150 to shell 210. Mount 310, which may be, for example, a bracket or faceplate, comprises opening 311 that allows a conduit to conduct air from control unit 150 to air cell 230 through shell 210. Thus, when the user activates control unit 150, the air pump in control unit 150 may selectively inflate and deflate air cell 230 in order to apply compression to the user's limb.

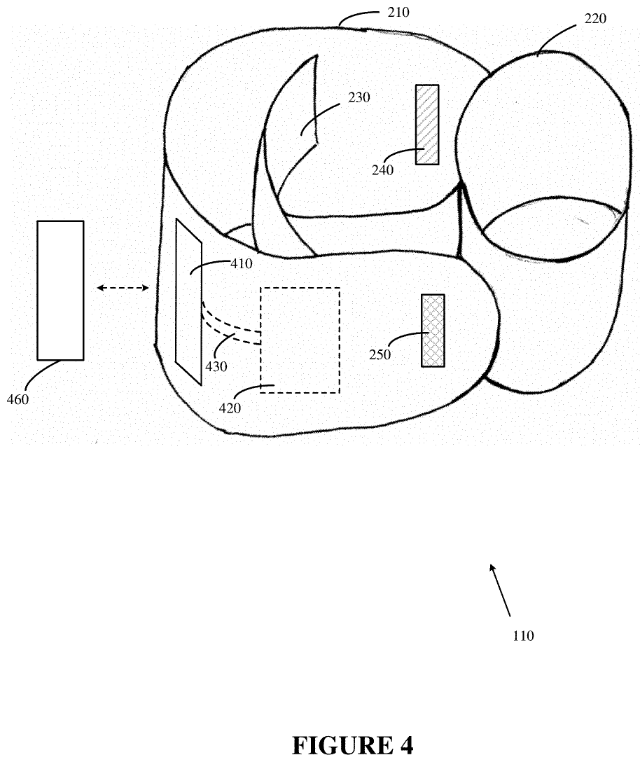

FIG. 4 illustrates an exploded view of compression therapy device 110 according to another embodiment of the disclosure. In FIG. 4, a control unit and a power strip or cable (indicated by dotted lines) are disposed internally to shell 120 and only a battery is mounted externally, thereby giving CTD 110 a smaller profile. CTD 110 comprises mount 410, internal control unit 420, internal power strip 430, and battery 460. As in FIG. 3, mount 410 may be, for example, a bracket or faceplate that allows battery 460 to be removably coupled to shell 210. A conduit (not shown) conducts air from control unit 420 to air cell 230 through an opening in shell 210. When battery 460 is coupled to mount 410, electrical power is transferred to control unit 420 via power strip 430.

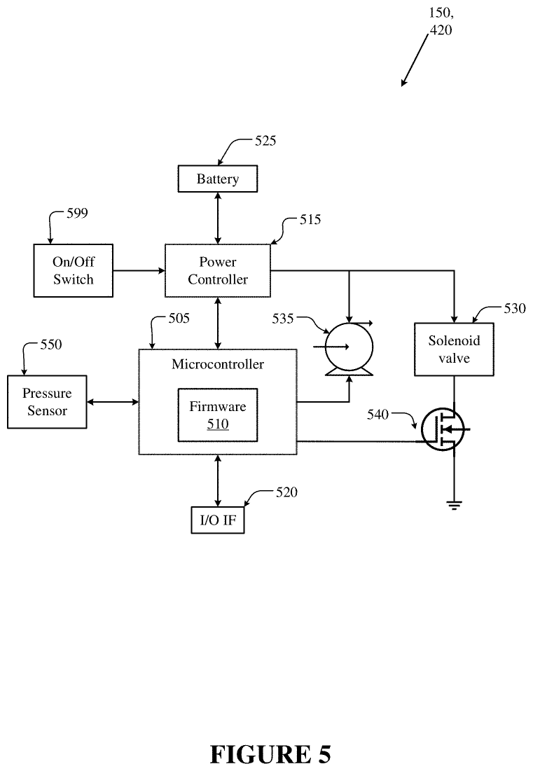

FIG. 5 illustrates in greater detail control unit 150 (or 420) of compression therapy device 110 according to one embodiment of the disclosure. Control unit 420 comprises microcontroller 505, firmware 510, power controller 515, input/output interface (I/O IF) 520, solenoid valve 530, air pump 535, power transistor 540, pressure sensor 550, and ON/OFF switch 599. In the case of external control unit 150, internal battery 525 is also included. In the case of internal control unit 420, battery 525 is not part of control unit 420, which is instead coupled to external battery 460. In the case of internal control unit 420, ON/OFF switch 599 may be implemented as a button on the exterior of external battery 460. In the case of external control unit 150, ON/OFF switch 599 may a button on the exterior of external control unit 150.

I/O IF 520 provides a user (or a remote device) a means for controlling the operation of CTD 110. In the case of external control unit 150, I/O IF 520 may comprise one or more selector buttons or dials that allow the user to select a particular type of therapy by adjusting the amount of compression, the frequency of compression, the duration of therapy, and the like. In the case of either external control unit 150 or internal control unit 420, however, I/O IF 520 may instead be a wireless interface, such as a Bluetooth transceiver, controlled by an external wireless device. Advantageously, the external wireless device may be a mobile phone that executes an application that communicates with I/O IF 520. This allows a user to initiate and control a therapy session using the control panel on the mobile phone screen instead of using selector buttons on the exterior of the actual CTD device 110.

Using an app on a mobile phone also provides a capability for real-time reporting on user compliance. Monitored data may include time and date of use, amount of time or frequency of each therapy session, pressure rate provided throughout the therapy session, average blood pressure throughout the therapy session, ambulation or steps throughout the therapy session.

For the sake of simplicity, it will be assumed hereafter that internal control unit 420 is being described, except where context indicates that external control unit 150 is being described. The present disclosure does not require that the components of control unit 420 include particular technologies. However, in an advantageous embodiment, air pump 535 may comprise a piezoelectric micro-pump and control unit 420 may comprise flexible printed circuit boards and a flexible battery. This may offer advantages such as reduced size and low noise, even silence within the human hearing range. In an exemplary embodiment, therapeutic pressure may be between 30-55 mmHg.

Microcontroller 505 executes instructions in firmware 510 to control the overall operation of control unit 420. Among other functions, firmware 510 causes microcontroller 505 to perform the following functions: i) power on control unit 420 using a momentary push button (i.e., ON/OFF switch 599), ii) report battery 460 status, and iii) monitor battery voltage and shut down control unit 420 if the voltage level is critical. Power controller 515 distributes power from battery 460 (or 525) after ON/OFF switch 599 is turned ON to the other components of control unit 420, including microcontroller 505, pump 535, solenoid valve, pressure sensor 550, and I/O IF 520.

Pressure sensor 550 is pneumatically configured to measure air pressure within air cell 230. If microcontroller 505 receives a pressure measurement from pressure sensor 550 that is too high, microcontroller 505 switches on power transistor 540 to thereby activate solenoid valve 530. Valve 530 releases or vents the excess pressure and permits air cell 230 to empty into the atmosphere.

During routine operation, firmware 510 causes microcontroller 505 to energize pump 535 and solenoid valve 530 until pressure reaches (30-55) mmHg. If pressure does not reach (30-55) mmHg after 30 seconds, then firmware 510 causes microcontroller 505 to: i) generate a low-pressure warning or error message, ii) emit a long beep or other audible signal to alert the user; and iii) de-energize CTD 110. However, if pressure does reach (30-55) mmHg within 30 seconds, then firmware 510 causes microcontroller 505 to: i) de-energize pump 535 and solenoid valve 530 and ii) repeat the cycle continuously or until the therapy duration period expires.

Using advanced pumping technologies, CTD 110 achieves reduced size with increased performance and efficacy. This allows the opportunity for much needed optimization, including a smaller form factor that fits under garments and low noise within human hearing range. The use of miniaturized components allows for more efficiency and shorter intervals with regard to pumping time, without sacrificing the recommended therapeutic levels of 30-50 mmHg. This gives CTD 110 an advantage over prior devices by reducing power consumption, resulting in increased battery life performance.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An apparatus for performing compression therapy on a person comprising:
a sleeve configured to encircle a first portion of a limb of the person and to hold the apparatus in place on the limb of the person;
a shell configured to encircle the first portion of the limb of the person, wherein the shell is positioned outside of the sleeve with respect to the first portion of the limb;
a bladder comprising at least one air cell, wherein the bladder is disposed between the sleeve and the shell; and
a control unit comprising an air pump, the control unit configured to cause the air pump to pump air into the at least one air cell, thereby inflating the bladder,
wherein the control unit is disposed within an interior compartment of the shell.

2. The apparatus as set forth in claim 1, wherein the sleeve is removably attached to the shell and to the bladder such that the shell and the bladder are held in place with respect to each other.

3. The apparatus as set forth in claim 1, wherein the shell is substantially rigid such that the diameter of the shell is substantially fixed when the shell is encircling the first portion of the limb.

4. The apparatus as set forth in claim 3, wherein inflation of the bladder causes the bladder to press inward against the sleeve such that a compression is applied to the first portion of the limb.

5. The apparatus as set forth in claim 4, wherein the control unit is further configured to cause the air pump to withdraw air from the at least one air cell, thereby deflating the bladder.

6. The apparatus as set forth in claim 5, wherein the control unit is further configured to cause the air pump to intermittently inflate and deflate the bladder, thereby applying a plurality of compressions to the first portion of the limb.

7. The apparatus as set forth in claim 6, wherein the control unit further comprises an interface configured to receive input information from the person, where the control unit uses the input information to control the plurality of compressions applied to the first portion of the limb.

8. The apparatus as set forth in claim 7, wherein the control unit uses the input information to control an amount of pressure associated with the plurality of compressions applied to the first portion of the limb.

9. The apparatus as set forth in claim 7, wherein the control unit uses the input information to control a frequency associated with the plurality of compressions applied to the first portion of the limb.

10. The apparatus as set forth in claim 7, wherein the control unit uses the input information to control a duration associated with the plurality of compressions applied to the first portion of the limb.

11. The apparatus as set forth in claim 7, wherein the interface comprises a wireless transceiver configured to communicate with a remote control device operated by the person.

12. The apparatus as set forth in claim 11, wherein the remote control device operated by the person comprises a mobile phone.
